(19) United States
(12) Patent Application Publication
(10) Pub. No.: US 2025/0010599 A1
(43) Pub. Date: Jan. 9, 2025

(54) Planar Structure of a Polymer Matrix and Textile Particles Embedded Therein

(71) Applicant: Rhenoflex GmbH, Ludwigshafen (DE)

(72) Inventors: Sebastian Ames, Mannheim (DE); Gunter Scharfenberger, Frankenthal (DE); Kim Garth, Bensheim (DE); Asan Shirka, Ludwigshafen (DE); Robert Grüneberg, Reilingen (DE)

(21) Appl. No.: 18/708,672

(22) PCT Filed: Nov. 23, 2022
(86) PCT No.: PCT/EP2022/082996

§ 371 Date: May 9, 2024

(30) Foreign Application Priority Data
Nov. 24, 2021 (EP) 21210163.8

(51) Int. Cl. B32B 27/20; B29B 9/02; B29B 9/08; B29B 9/12; B29C 48/00; B29C 48/08; B32B 5/02; B32B 27/12; B32B 27/36; B32B 27/40; B29K 67/00; B29K 75/00; B29K 105/16; B29K 511/08

(52) U.S. Cl. CPC B32B 27/20; B29B 9/02; B29B 9/08; B29B 9/12; B29C 48/0021; B29C 48/08; B32B 5/022; B32B 27/12; B32B 27/36; B32B 27/40; B29K 2067/00; B29K 2067/046; B29K 2075/00; B29K 2105/16; B29K 2511/08; B29K 2995/0077; B29K 2995/0082; B29K 2995/0094; B32B 2264/303; B32B 2270/00; B32B 2307/54; B32B 2307/546

(57) ABSTRACT

The present invention relates to a sheet consisting of textile particles embedded in a polymer matrix, and a process for the preparation thereof, and the use thereof. Further, the present invention relates to a layer structure consisting of the sheet according to the invention and at least one other layer.

The present invention relates to a sheet consisting of textile particles embedded in a polymer matrix, and a process for the preparation thereof, and the use thereof. Further, the present invention relates to a layer structure consisting of the sheet according to the invention and at least one other layer.

The textile and leather industry is one of the oldest and most important economic branches of the manufacturing and processing industries, which process, in particular, materials of animal and plant origin into clothing and other articles.

In the processing of textiles and leather, the problem frequently arises that these materials cannot be recycled and thus recirculated into the value creation cycle, or only so at a considerable expense. There are actually a few other possible applications for textile and leather scrap from the production thereof or from the processing industry, in addition to a limited recycling of used materials into the market, but this is complicated by the fact that these materials were treated, such as dyed or tanned, before being processed and thus can be returned to a useful condition only by complicated treatment

One process focusses on the recovery of leather in the form of bonded leather, also known as reconstituted leather. In this process, offcuts from the leather-processing industry as well as chrome shavings as obtained in the shaving of freshly tanned leather hides in tanneries are provided in several steps into large rolls or sheets for further processing. Thus, the leather scraps are finely shredded on a machine at first, followed by mixing with plant-based tanning agents, natural rubber, natural lipids, and water. In a second tanning process, the leather fibers become entangled and thus form a uniform material that can be smoothed, ground and subsequently further processed. In this way, wall coverings, floor coverings, book spines, belts and other accessories can be produced.

US 2007/0184742 describes, among other things, a composite material comprising: leather fibers; a binding agent; non-leather fibers; and a cushioning agent.

US 2007/0043128 relates to a method of making a carpet backing from carpet scrap comprising: (A) obtaining carpet scrap having a substrate and a backing coating secured to the substrate, wherein said backing coating originates from a polyurethane reactive mixture; (B) shredding the carpet scrap into fragments; (C) melt-mixing the shredded carpet scrap fragments under a pressure of from 2413.2 kPa to 3102.6 kPa and at a temperature of from 120° C. to 220° C.; (D) forming agglomerates from the molten carpet scrap fragments; (E) grinding the agglomerates into a powder; and (F) forming a recycled backing coating comprising the ground powder.

In their article “Polylactic Acid Biocomposites Filled with Waste Leather Buff”, issued in J Polym Environ (2017) 25:1099-1109, T. Ambone et al. describe eco-biocomposites that are prepared using waste leather buff as a filler material and polylactic acid as a matrix material.

US 2002/0032253 discloses a thermoplastic composite material that contains organic fiber in a thermoplastic binder.

US 2006/0194486 relates to a composite material for thermally formable shoe components on an organic fiber base containing an organic fiber material and a binding agent.

However, known methods mostly have the disadvantage of being very complicated and relying on the use of further raw materials, such as water. In many cases, the leather scrap has to be processed into fibers in complicated operations before it can be converted further, for example, as described in US 2007/0184742 and US 2002/0032253. Therefore, there is still a need for simplified processes for recycling textile and leather scraps, and materials that can be produced from such recycled raw materials and enable some reasonable further processing.

In view of the above, it has been the object of the present invention to provide a material and a process for the preparation thereof that can overcome the above mentioned drawbacks.

Surprisingly, it has been found that this object is achieved by a sheet produced from a polymer matrix in which textile particles are embedded, wherein textile scraps, in particular, can be used as such textile particles.

Therefore, in a first aspect, the present application relates to a sheet consisting of a polymer matrix with textile particles embedded therein, said sheet having a proportion of from 20 to 60% by weight textile particles.

Unlike in methods described in the prior art, it has been surprisingly found within the scope of the present invention that the textile scraps need not be processed into fibers in some complicated way, but can be employed in the form of simple particles.

Within the scope of the present invention, “particles” have no defined aspect ratio as opposed to fibers. The textile particles employed within the scope of the present invention are preferably obtained by mechanically comminuting textile scraps, especially by shredding or grinding.

Within the scope of the present invention, a “textile” means textile and non-textile raw materials that can be processed into linear, two-dimensional and three-dimensional fabrics by various methods. In particular, “textile raw materials” means natural fibers, while the term “non-textile raw materials” covers leather, in particular.

Surprisingly, it has been found that the sheet according to the invention offers a simple method of further processing textile scraps. Therefore, an embodiment is preferred in which said textile particles are textile scraps. Within the scope of the present invention, “textile scraps” means textiles and textile materials that are not suitable for further processing, or were recovered from processed materials, such as cutting residues and/or used textiles, for example. In particular, with leather scraps, there is a difficulty in that these are usually not accessible to recycling because of their processing history, such as tanning, and therefore mostly have to be combusted. Within the scope of the present invention, it has been surprisingly found that tanned leather scraps may also be processed, without having an adverse impact on the quality of the sheet according to the invention. Therefore, an embodiment is particularly preferred in which said textile particles are leather scraps. Suitable scraps include, for example, offcuts or chrome shavings, but also processed leather.

The sheet according to the invention makes a valuable contribution to the sustainable utilization of raw materials. With the polymers used for the polymer matrix, this contribution can be further supported. Therefore, the polymer matrix is preferably formed from biopolymers, both bio-based and biodegradable ones, and recycled polymers. Further preferably, virgin polymers may also be employed according to the invention. More preferably, said polymer matrix is formed from recycled polymers. Within the meaning of the present invention, a “virgin polymer” means a brand new polymer, whereas “recycled polymer” designates one that has already been subjected to further processing steps and has been recovered within the scope of the value cycle. The polymer matrix of the sheet according to the invention can be adapted depending on need. In a preferred embodiment, said polymer matrix is selected from the group consisting of polyolefins, polyesters, TPU esters, ether-based TPO, PCL, PLA, PA, TPE-S, TPE-E, TPE-A, EVA, PVA, mixtures and copolymers thereof. More preferably, said polymer is selected from the group consisting of TPE, TPU, TPA, EVA, and PA, and mixtures and blends thereof. In particular, preferred as biopolymers are those selected from the group consisting of PLA, cellulose, lignin, tannin, mixtures thereof, and copolymers thereof.

According to the invention, thermoplastic polymers are preferably employed for the polymer matrix. Preferably, said polymer is accordingly selected from the group consisting of thermoplastic polyesters, thermoplastic polyamides, thermoplastic polyurethanes, thermoplastic EVAs, and mixtures and copolymers thereof. In a further preferred embodiment, a mixture of polymers may also be used. Preferably, two or more different polymers are used. More preferably, a mixture of polymers two or more polymers selected from the group consisting of TPE, TPU, TPA, EVA and PLA is used as the polymer matrix. By selecting thermoplastic polymers for producing the polymer matrix, the sheet according to the invention can be provided with an advantageous thermoplastic deformability, which offers a wide variety of possible applications. Therefore, an embodiment is preferred in which the sheet according to the invention is thermoplastically deformable. In a preferred embodiment, the sheet according to the invention has a deformation temperature of from 80 to 180° C. A deformation temperature within the claimed range ensures the compatibility of the sheet according to the invention with the common processing temperatures, especially in the fields of shoe manufacturing and production of lifestyle products, so that a simple and efficient processing of the sheet is achieved.

For the thermoplastic character of the polymer matrix not to be lost, the proportion of textile particles in the polymer matrix should not exceed a particular content. Therefore, the sheet according to the invention has a proportion of textile particles of from 20 to 60% by weight, preferably from 25 to 50% by weight, specifically preferred from 25 to 40% by weight. The values respectively relate to the total weight of the sheet.

In a further preferred embodiment, the sheet according to the invention has a proportion of recycled materials of at least 40%, preferably at least 60%, and especially at least 80%, based on the total material, wherein said recycled material includes both the polymer matrix and the textile particles.

The sheet according to the invention can be further processed in a variety of ways. Depending on the kind of further processing, it has been found advantageous to provide the sheet in the form of flat sheets or rolls. Therefore, an embodiment is preferred in which said sheet is provided in the form of material sheets or rolls.

The thickness of the sheet according to the invention can be selected depending on application. In a preferred embodiment, the sheet according to the invention has a thickness of from 0.5 to 2.5 mm.

The sheet according to the invention is characterized by a number of advantageous mechanical properties that allow for a variety of applications and simple further processing. The properties of the sheet according to the invention can be controlled, in particular, by selecting appropriate polymers for the polymer matrix. Thus, a broad range of starting materials are available that allow for adaptation of the properties of the sheet according to the invention to the respective requirements.

In addition to an advantageous deformability, the sheet according to the invention further shows some bending strength as a measure of loadability, which recommends the sheet according to the invention, in particular, for use as uppers, for example, for shoes or bags. Therefore, an embodiment is preferred in which said sheet according to the invention has a bending strength of from 10 to 10,500 mN, preferably from 15 to 10,000 mN. Presently, the bending strength was determined by analogy with DIN 53121, and designates the force necessary to bend a specimen having a clamping length of 50 mm by 45°. In some embodiments, said sheet according to the invention has a bending strength of from 10 to 2,000 mN. In other embodiments, said sheet according to the invention may have a bending strength of from 6000 to 10,000 mN.

In a further preferred embodiment, the sheet according to the invention has a tear strength of from 1.5 to 30 N/mm², preferably from 2 to 25 N/mm². Said “tear strength” or “tensile strength” within the scope of the present invention refers to the maximum mechanical tensile stress that the sheet can withstand, and can be determined according to DIN EN ISO 527 using a type 5 specimen.

Further, the elongation at break of the sheet according to the invention can be adjusted by selecting an appropriate polymer matrix. In general, it has been found advantageous for the main fields of application of the sheet according to the invention if the elongation at break is from 5 to 150%. The elongation at break can be determined, for example, according to DIN EN ISO 527.

In order to extend the fields of application of the sheet according to the invention, it may be applied to a support, for example, or its surface may be treated in some other way. In a preferred embodiment, therefore, the sheet according to the invention is characterized by having a coating on the upper and/or lower sides thereof. The coating can be used, in particular, to adapt the mechanical and optical properties of the sheet according to the invention. Thus, for example, the surface can be stabilized, or the abrasion resistance increased. Further, the color design of the sheet according to the invention can be achieved in this way. Such coating may be any materials, wherein textile materials and plastic materials are preferred. Alternatively, said coating may be achieved by applying an adhesive, especially by applying a hot-melt adhesive. In this manner, for example, a bonding to an outer fabric and/or a lining, as used for manufacturing shoes, can be produced. Preferably, said coating is selected from the group consisting of textiles or polymer mixtures, wherein said textiles are polyester and/or natural fiber textiles, in particular. In a particularly preferred embodiment, said coating is an at least in part recycled material, especially a completely recycled material.

The sheet according to the invention may be combined with other materials, and in particular, be processed into layer structures. Accordingly, the present invention further relates to a two-dimensional layer structure consisting of the sheet according to the invention and at least one other layer applied thereto, wherein said other layer is a textile layer, plastic layer, or adhesive layer.

The present invention further relates to a process for preparing said sheet according to the invention. Said process according to the invention includes the following steps:
a) providing textile scraps;
b) shredding said textile scraps;
c) agglomerating the shredded textile scraps in the presence of a polymer;
d) grinding the agglomerated textile scraps to a powder; and
e) extruding the powder to obtain a sheet.

Within the scope of the process according to the invention, it has surprisingly been found that the textile scraps need not meet any particular requirements, but, for example, unsorted scraps may also be employed, so that complicated sorting steps can be dispensed with. Further, it has surprisingly been found that scraps for which otherwise no further use is found, such as tanned leather scraps, may also be employed, without qualitative losses of the sheet occurring.

In order to facilitate the feeding of the ground textile scraps to the extrusion unit, the process according to the invention may preferably include an additional granulation step, which is performed upstream of said extruding of the powder.

In order to adapt the properties of the powder before the extrusion, other components, such as additives or other polymers, can be admixed with the ground powder. Preferably, such additives will be metered while the powder is extruded.

In another preferred embodiment, the process according to the invention comprises another step of surface treatment, which may be combined with the step of extruding, or is performed subsequently. Within the scope of this step, the surface of the sheet can be adapted in accordance with the intended use. Thus, in an embodiment according to the invention, the upper and/or lower sides of the sheet can be provided with a coating by lamination.

The provided textile scraps are shredded at the beginning of the process. It has proven advantageous herein if the scraps are shredded to a maximum size of not more than 1 cm, in which the maximum size indicates the maximum dimension of the individual shredded textile scraps. Preferably, the textile scraps have a maximum size of 0.8 cm, preferably 0.6 cm, after the shredding. For this size, an optimum throughput and an effective agglomeration could be achieved. Said shredding can be effected in several steps.

In step c) of the process according to the invention, the shredded textile scraps are mixed with a polymer and agglomerated. The weight ratio of shredded textile scraps to the polymer is preferably from 30:70 to 70:30, especially from 45:55 to 55:45.

In the subsequent step, the agglomerated textile scraps are ground to a powder. Preferably, the powder thus obtained has a mean particle size D50 of from 100 to 1000 μm, preferably from 250 to 500 μm, as determined by a sieve analysis using an air jet sieve. Surprisingly, it has been found that significantly smaller particle diameters can be obtained in this way as compared to a case where the textile scraps are ground in a conventional way without being previously contacted with a polymer.

The temperature at which the agglomeration is performed depends on the matrix polymer employed. In a preferred embodiment, the agglomeration of the shredded textile scraps is performed at a temperature of from 80° C. to 250° C.

The sheet according to the invention and the layer structure according to the invention can be employed in a variety of ways, but are particularly suitable for use as a reinforcing material and top material. Therefore, the present invention further relates to the use of a sheet according to the invention and/or a layer structure according to the invention as a top material or reinforcing material. Preferably, said top material is one as employed, in particular, in the manufacturing of shoes and/or bags and/or covers. Further, the sheets and/or layer structures according to the invention can be employed as packing, for the preparation of accessories, such as belts and purses, for veneering and for the preparation of clothing, decorative objects, or furniture.

The present invention is further explained by means of the following Examples, which should by no means, however, be understood as limiting the idea of the invention.

### EXAMPLES

The following sheets were prepared from a polymer matrix and recycled leather scraps by the process according to the invention, and their mechanical properties were measured:

TABLE 1

| Example | 1* | 2 | 3 | 4 | 5 | 6 | 7 |
|---|---|---|---|---|---|---|---|
| Leather [% by | 25 | 25 | 50 | 25 | 50 | 40 | 25 |
| weight] | | | | | | | |
| Polymer matrix | TPS/EVA: | TPU | TPU | EVA | EVA | TPE-A | PP/EVA: |
| [w/w, % by | 50/25 | | | | | | 50/25 |
| weight] | | | | | | | |
| | ad 100 | ad 100 | ad 100 | ad 100 | ad 100 | ad 100 | ad 100 |

+) backed with a textile on one side
TPS: Styrene block copolymer
EVA: Ethylene/vinyl acetate copolymer
TPU: thermoplastic polyurethane
TPE-A: Thermoplastic polyamide
PP: Polypropylene

TABLE 2

| | Bending strength | | Tensile strength | | Elongation at break | |
|---|---|---|---|---|---|---|
| | [mN]¹⁾ | | [N/mm²]²⁾ | | [%]³⁾ | |
| Example | cd | md | cd | md | cd | md |
| 1 | 46 | 160 | 2.4 | 3.6 | 36.6 | 19.7 |
| 2 | 1010 | 1318 | 8.2 | 8.5 | 23.1 | 50.2 |
| 3 | 1075 | 1417 | 8.9 | 8.1 | 8.3 | 7.9 |
| 4 | 152 | 335 | 3.1 | 3.4 | 69.5 | 124.9 |
| 5 | 359 | 503 | 2.8 | 2.1 | 21.0 | 24.3 |
| 6 | 315 | 610 | 4.6 | 4.6 | 47.8 | 36.8 |
| 7 | 1136 | 1286 | 6.3 | 5.6 | 10.8 | 17.1 |

As another example, a layer structure according to the invention was prepared from a sheet according to the invention, 25% by weight, and a polymer matrix made from 25% by weight TPU, 30% by weight PLA, and 20% by weight PCL as the core, which was coated with a layer of PES non-woven and an adhesive layer applied thereto, as an outer layer on both sides. The measured properties of the layer structure are summarized in Table 3.

TABLE 3

| | Bending strength | | Tensile strength | | Elongation at break | |
|---|---|---|---|---|---|---|
| | [mN]¹⁾ | | [N/mm²]²⁾ | | [%]³⁾ | |
| Example | cd | md | cd | md | cd | md |
| 8 | 1328 | 1001 | 21.2 | 15.9 | 27.1 | 33.3 |

¹⁾determined according to DIN EN ISO 53121 on a specimen with a clamping length of 50 mm at an angle of 45°
²⁾determined according to DIN EN ISO 527 with a type 5 specimen
³⁾determined according to DIN EN ISO 527
cd: cross direction
md: machine direction

As can be seen from the data in Tables 2 and 3, sheets and layer structures according to the invention having a broad range of properties that can be adapted and optimized depending on the desired application are available. The data further show that the process according to the invention allows for a reliable reprocessing of textile scraps, especially leather scraps.

1. A sheet consisting of a polymer matrix and textile particles embedded therein, said sheet having a proportion of textile particles of from 20 to 60% by weight.

2. The sheet according to claim 1, characterized in that said textile particles are textile scraps.

3. The sheet according to claim 1, characterized in that said polymer matrix is formed from biopolymers, biodegradable polymers, recycled polymers, virgin polymers, or mixtures thereof.

4. The sheet according to claim 1, characterized in that said sheet has a proportion of from 20 to 50% by weight of textile particles.

5. The sheet according to claim 1, characterized in that said sheet has a thickness of from 0.5 to 2.5 mm.

6. The sheet according to claim 1, characterized in that said sheet has a coating on the upper and/or lower sides thereof.

7. The sheet according to claim 1, characterized in that said sheet has a bending strength of from 10 to 10,500 mN.

8. The sheet according to claim 1, characterized in that said sheet has a tensile strength of from 1.5 to 30 N/mm², as determined according to DIN EN ISO 527 with a type 5 specimen.

9. The sheet according to claim 1, characterized in that said sheet has an elongation at break of from 5 to 150%, as determined according to DIN EN ISO 527.

10. A two-dimensional layer structure consisting of a sheet according to claim 1, and at least one other layer, wherein said other layer is a textile layer, plastic layer, or adhesive layer.

11. A process for preparing a sheet according to claim 1, characterized in that said process comprises the following steps:
a) providing textile scraps;
b) shredding said textile scraps;
c) agglomerating the shredded textile scraps in the presence of a polymer;
d) grinding the agglomerated textile scraps to a powder; and
e) extruding the powder to obtain a sheet.

12. The process according to claim 11, characterized in that said process comprises another step of laminating, which may be combined with the step of extruding, or is performed subsequently.

13. The process according to claim 11 characterized in that the textile scraps have a maximum size of 0.8 cm after the shredding.

14. The process according to claim 11, characterized in that the powder obtained in step d) has a mean particle size D50 of from 100 to 1000 μm, as determined by a sieve analysis.

15. (canceled)

16. The sheet according to claim 4, characterized in that said sheet has a proportion of from 25 to 40% by weight of textile particles.

17. The sheet according to claim 7, characterized in that said sheet has a bending strength of from 15 to 10,000 mN.

18. The sheet according to claim 7, characterized in that said sheet has a bending strength of from 10 to 2000 mN.

19. The sheet according to claim 8, characterized in that said sheet has a tensile strength of from 2 to 25 N/mm², as determined according to DIN EN ISO 527 with a type 5 specimen.

20. The process according to claim 11, characterized in that the textile scraps have a maximum size of 0.6 cm after the shredding.

21. The process according to claim 14, characterized in that the powder obtained in step d) has a mean particle size D50 of from 250 to 500 μm, as determined by a sieve analysis.
